(19) United States
(12) Patent Application Publication
(10) Pub. No.: US 2014/0190015 A1
(43) Pub. Date: Jul. 10, 2014

(54) Shearing Apparatus

(71) Applicant: Scott Forman, Albuquerque, NM (US)

(72) Inventor: Scott Forman, Albuquerque, NM (US)

(73) Assignee: Emvolution, Inc., Albuquerque, NM (US)

(21) Appl. No.: 13/734,868

(22) Filed: Jan. 4, 2013

(51) Int. Cl. B26B 13/08; B26B 3/00; B26B 13/22

(52) U.S. Cl. CPC B26B 13/08; B26B 13/22; B26B 3/00
USPC 30/146; 30/355; 30/254; 30/314

(57) ABSTRACT

A shearing apparatus comprising an index portion and a thumb portion that are pivotable relative to one another about a pivot mechanism. One of the thumb blade and index blade is provided with a serrated portion, while the other of the index blade and the thumb blade is provided with a cutting edge, such that the serrated portion and the cutting edge cooperate with one another during the relative pivoting movement of the index portion and the thumb portion to carry out a shearing or severing action. The shearing apparatus can alternatively comprise a single blade portion, pulled by a handle, and provided with a serrated portion. In both embodiments, the serrated portion has a configuration that presents a compound angle, which comprises a cutting edge angle and an angle relative to the longitudinal direction.

### BACKGROUND OF THE INVENTION

The present invention relates to a shearing apparatus, for example for use in emergency medicine and wilderness medicine environments, as well as in camping, hunting and fishing applications.

Several embodiments of a shearing apparatus, also known as shears, are disclosed in application Ser. No. 13/312,873, which is commonly owned by the assignee of the present application. The contents of this application Ser. No. 13/312,873 are hereby incorporated into the present disclosure by this reference thereto.

It is an object of the present application to improve the blade configuration of heretofore known shearing apparatus for better utilization of the cutting forces.

### BRIEF DESCRIPTION OF THE DRAWINGS

This object, and other objects and advantages of the present invention, will appear more clearly from the following specification in conjunction with the accompanying schematic drawings, in which:

FIG. 1 is a perspective view of one exemplary embodiment of a shearing apparatus of the present application;

FIG. 2a & 2b show the shearing apparatus of FIG. 1 with and without an additional ripping portion;

FIG. 3 is a close-up view of part of the serrated portion of the thumb blade of the shearing apparatus;

FIGS. 4-8 show details of the index blade and of the serrated portion of the thumb blade;

FIGS. 9 & 10 schematically illustrate angles of the teeth of the serrated portion; and

FIG. 11 is a perspective view of a further exemplary embodiment of a shearing apparatus of the present application.

### SUMMARY OF THE INVENTION

The shearing apparatus of one embodiment of the present application comprises an index portion having an index blade and a first pivot; a thumb portion having a thumb blade and a second pivot; and a pivot mechanism disposed through both the first and second pivots, wherein the index portion and the thumb portion are pivotable relative to one another about the pivot mechanism, further wherein one of the thumb blade and the index blade is provided with a serrated portion, while the other of the index blade and the thumb blade is provided with a cutting edge, further wherein the serrated portion and the cutting edge of the thumb blade and the index blade are configured to cooperate with one another during the relative pivoting movement of the index portion and the thumb portion to carry out a shearing or severing action, and wherein the serrated portion has a configuration that presents a compound angle.

The compound angle of the serrated portion, in other words of the teeth thereof, comprises a cutting edge angle and an angle relative to the longitudinal direction. In particular, the peaks and troughs of the teeth of the serrated portion extend at a downward angle, namely at an angle from a “high” edge of the thumb blade and into the body of the thumb blade. In addition, the peaks and troughs of the teeth of the serrated portion are disposed at an angle relative to the longitudinal direction of the thumb blade.

The surface of the index blade that extends between the cutting edge thereof and its outer surface can also extend at an angle relative to such outer side surface.

Pursuant to an alternative embodiment of applicant's shearing apparatus, a single blade portion or element is provided, which has a handle for pulling or pushing it. A serrated portion with a configuration that presents the aforementioned compound angle is provided on at least a portion of one side of the blade element.

Further specific features of the present application will be described in detail subsequently.

### DESCRIPTION OF SPECIFIC EMBODIMENTS

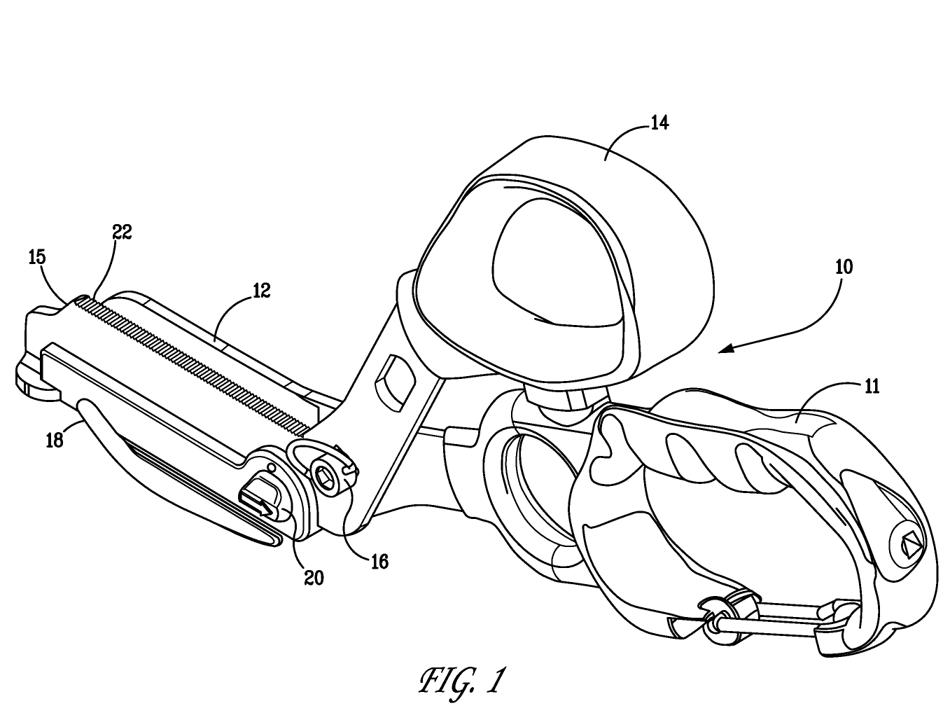

Referring now to the drawings in detail, one exemplary embodiment of applicant's shearing apparatus is illustrated in FIG. 1, and is designated generally by the reference numeral 10. Although the shearing apparatus can be configured for both right hand and left hand use in the illustrated embodiment, the shearing apparatus 10 has a right hand configuration and is provided with a finger or index portion 11, which includes an index blade 12. The shearing apparatus 10 is also provided with a thumb portion 14, which includes a thumb blade 15. The index portion 11 and the thumb portion 14 are pivotably interconnected by a pivot mechanism 16 which, for example, allows the index portion 11 and the thumb portion 14 to be pivoted relative to one another.

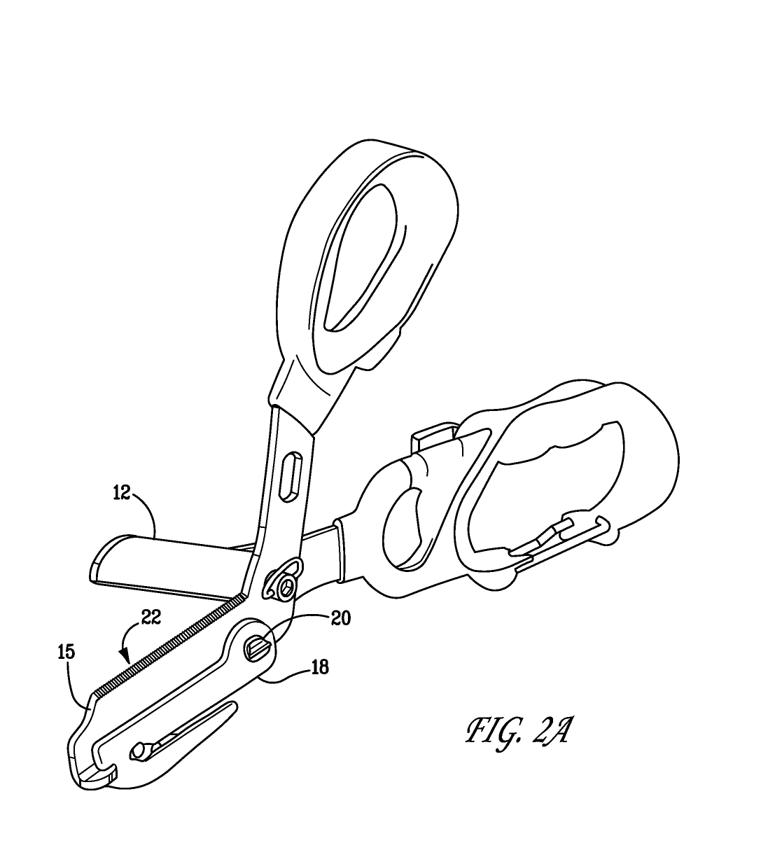

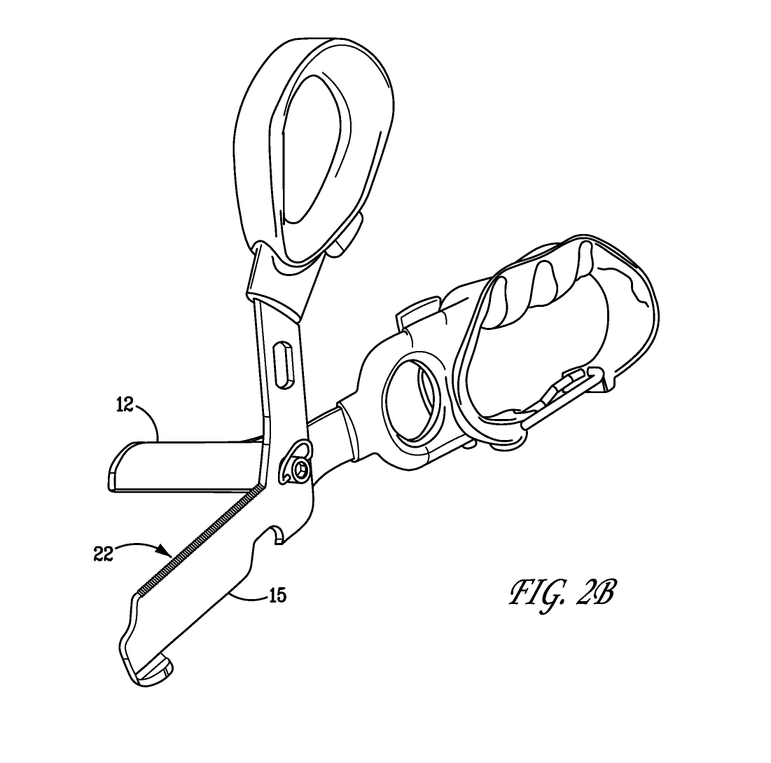

In the illustrated embodiment, the index blade 12 is shown as being straight (see e.g. FIG. 2), although it can be serrated, linear, curved, or any combination thereof for permitting efficient shearing of an article. Similarly, the thumb blade 15 is shown as being serrated, but could also be straight, linear, curved, or any suitable combination thereof for permitting efficient shearing of an article. The index blade 12 and the thumb blade 15 are in particular suitable for shearing through or partially through such articles or materials as gauze bandage material, fabric, textiles, sheet metals, composites, organic or synthetic materials, threads, ropes, Kevlar, clothing, and the like.

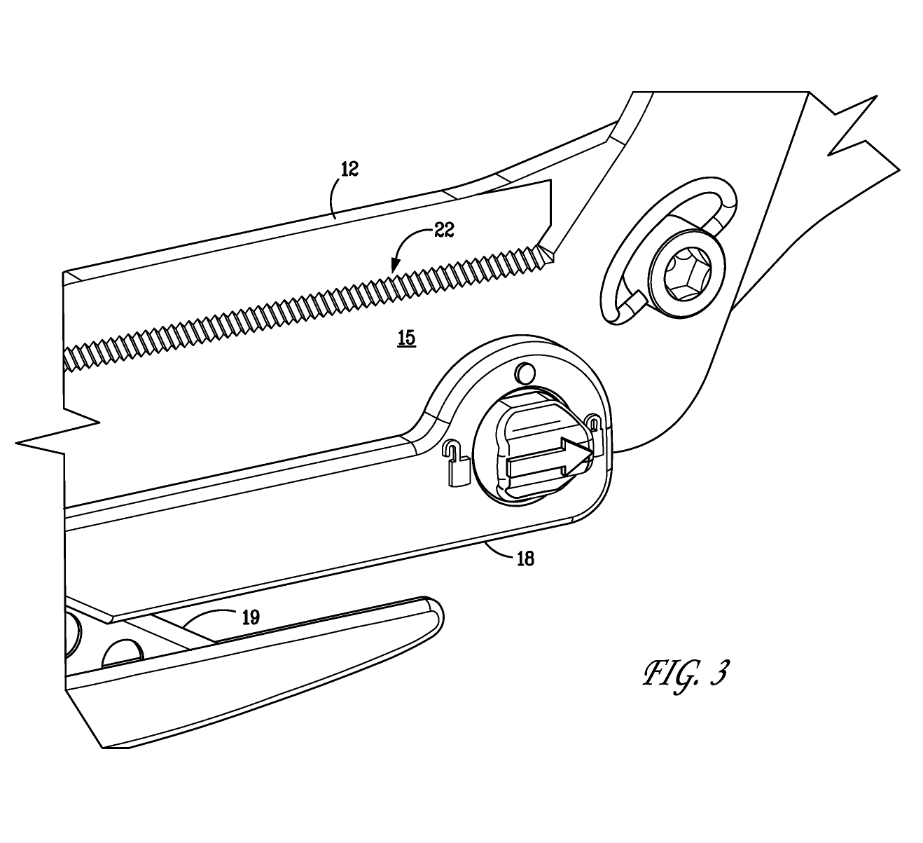

The shearing apparatus 10 of the present application can also be provided with a ripping portion or ripper 18, which is provided with a ripping blade 19 (FIG. 3) as an additional means to shear through an article or material. If the ripping portion 18 is a separate component, it can be fixedly or preferably removably secured to one of the blades, such as the thumb blade 15, by appropriate mounting means, by way of example only a pin, which is indicated generally in FIG. 1 by the reference numeral 20 (see FIG. 1, as well as FIG. 2a, with a ripper 18, and FIG. 2b, without a ripper).

Details regarding the configuration and operation of the shearing apparatus 10 described above can be found in the aforementioned U.S. application Ser. No. 13/312,873.

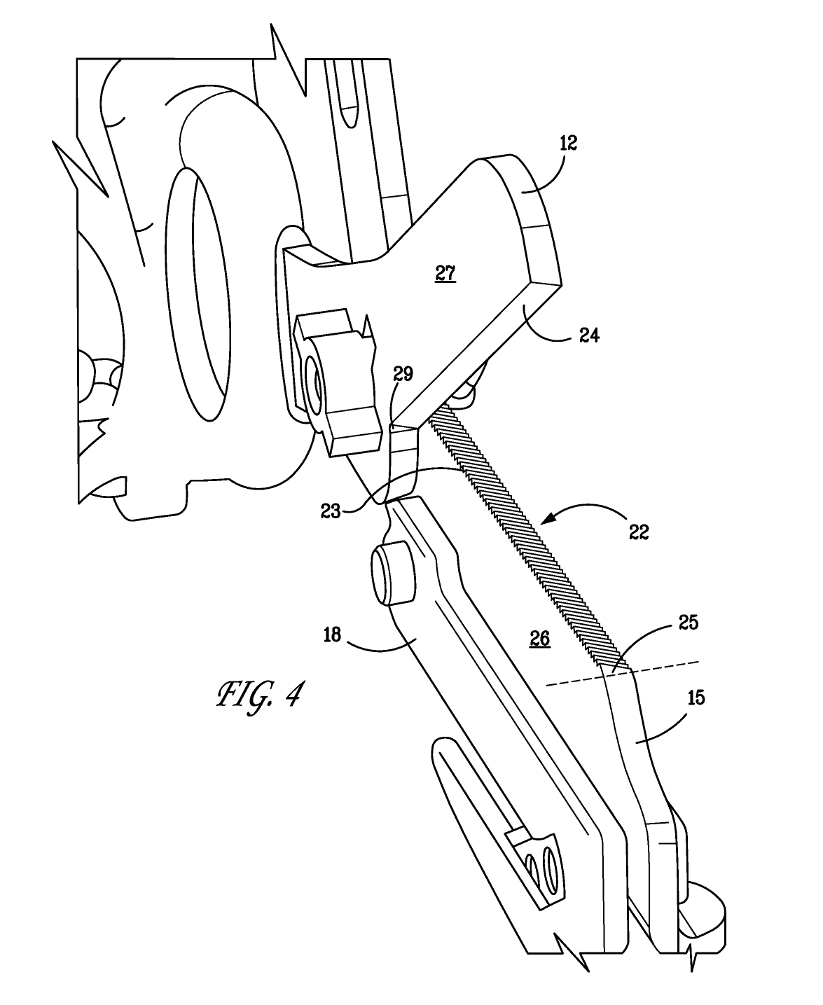

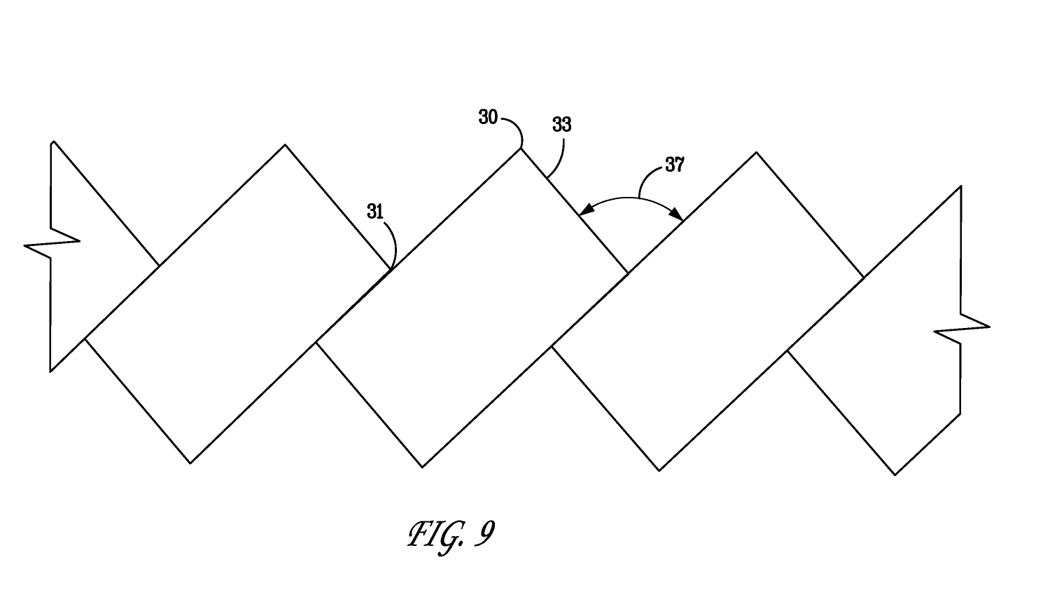

As indicated above, the thumb blade 15 of the thumb portion 14 can be serrated. In particular, in the illustrated embodiment, the thumb blade 15 is provided with a serrated portion 22. Details of this serrated portion 22 are illustrated in FIGS. 4 to 10, which show not only the compound angle configuration of the serrated portion 22, but also the angular nature of the teeth themselves of the serrated portion.

For example, FIG. 4 shows angles of the serrated portion 22 of the thumb blade 15, and of the index blade 12. In particular, it can be seen that the peaks and troughs of the teeth of the serrated portion 22 extend at a downward angle, in other words they extend at an angle from a “high” edge 23 of the thumb blade 15 that is configured to cooperate with the cutting edge 24 of the index blade 12, into the body of the thumb blade 15. This angle is designated by the reference numeral 25 in FIG. 4 and is defined between the peaks of the teeth of the serrated portion 22 and the inner side surface 26 of the thumb blade 15, namely relative to a direction of cut. The angle 25 can range from 72° to 78° and in one presently preferred embodiment is 75°. Similarly, that surface of the index blade 12 that extends between the cutting edge 24 thereof and the outer side surface 27 extends at an angle 29 relative to the outer side surface 27, and hence also at an angle relative to the inner side surface of the index blade 12, again from the “high” cutting edge 24 of the index blade 12 into the body of the index blade. This angle 29 can also range from 72° to 78° and in one presently preferred embodiment is 75°.

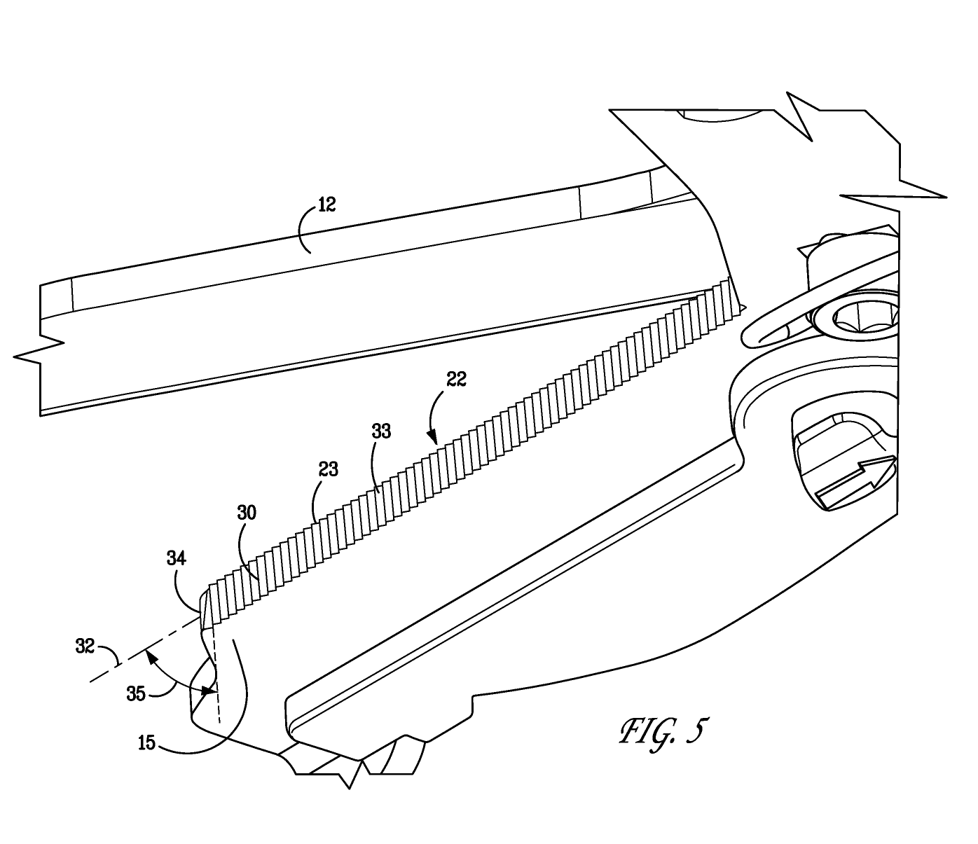

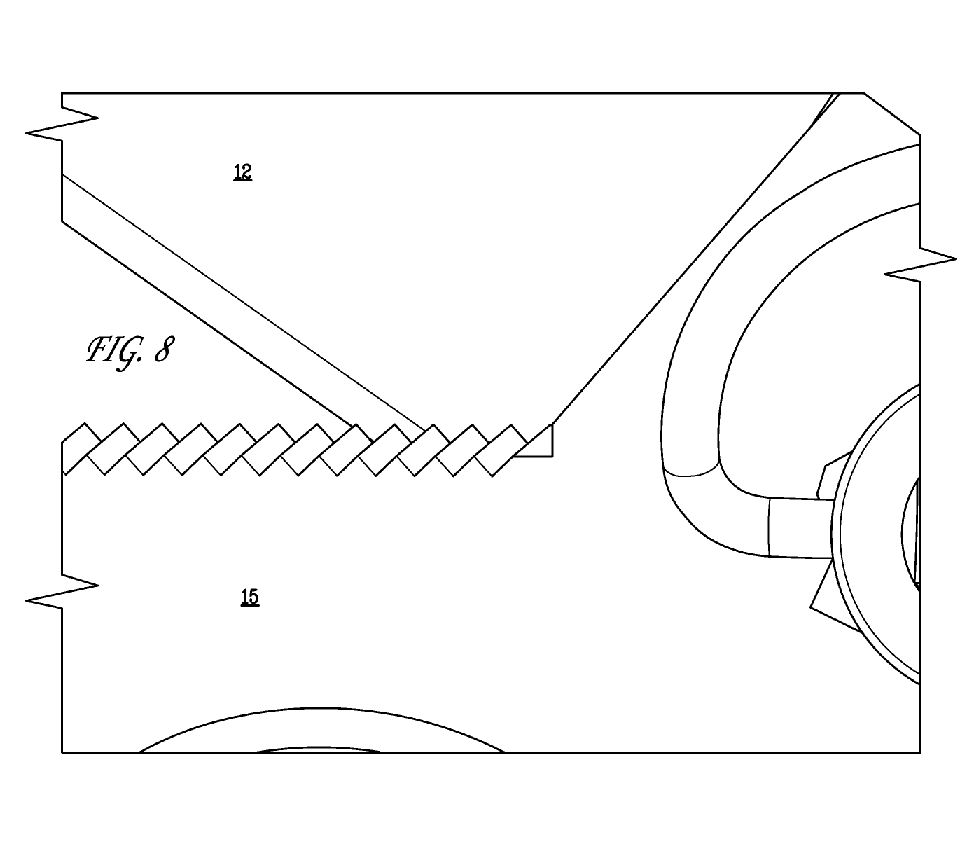

FIGS. 5-8 additionally show that the peaks 30 and troughs 31 of the teeth 33 of the serrated portion 22 are disposed at an angle to the longitudinal direction 32 of the thumb blade 15. In particular, the peaks 30 and troughs 31 extend outwardly from the inner “high” edge 23 of the thumb blade 15 in a direction toward an outer end 34 of the thumb blade. This angle, designated 35 in FIGS. 5 and 7, can also range from 72° to 78°, and in one preferred embodiment is 75°.

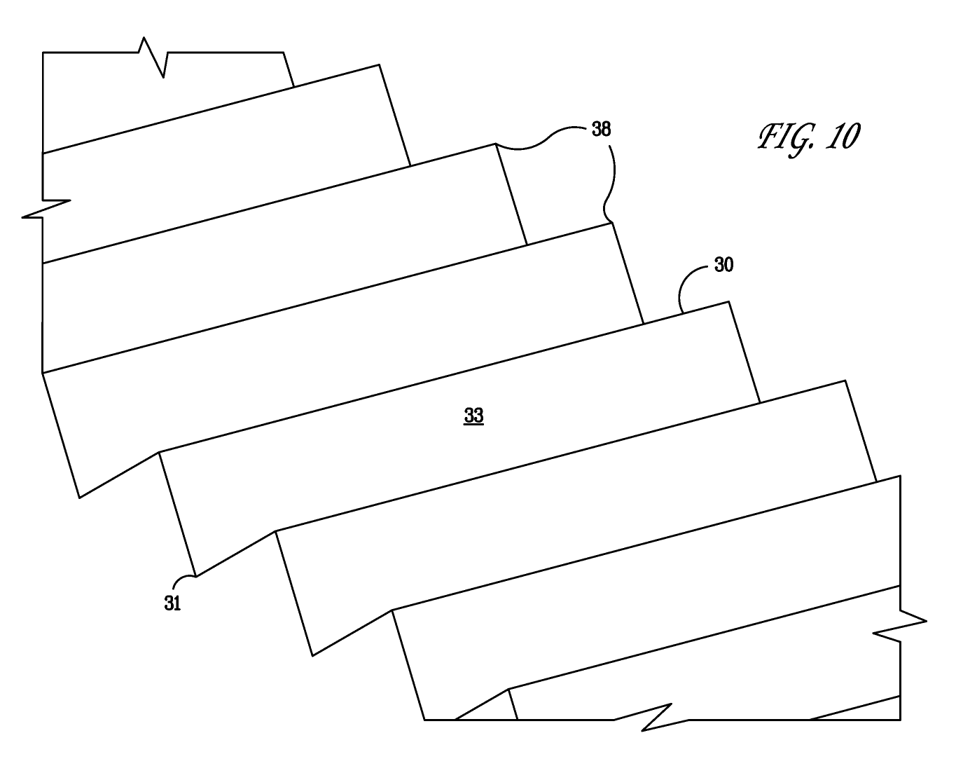

The angles of the teeth 33 themselves are schematically illustrated in FIGS. 9 and 10. For example, the angle 37 at the root of the teeth 33, in other words defined by the trough 31 and the adjacent side surfaces of the teeth 33, can range from 60° to 90° and in one presently preferred embodiment is 75°. Thus, the angle at the peaks 30 of the teeth 33, in other words defined by the peak 30 and the adjacent side surfaces of the teeth 33, can similarly range from 60° to 90°, and in one presently preferred embodiment is 75°. Furthermore, the sides of the teeth 33, below the inner edge 23 and adjacent to the inner side surface 26 of the thumb blade 15, are preferably cut at an inwardly extending angle of from 72° to 78° and in one presently preferred embodiment 75°, as schematically shown in FIG. 4. Finally, the peak to peak spacing 38 of the teeth 33 relative to one another is preferably uniform and is preferably in the range of 0.014 to 0.028 inches (see the schematic illustration in FIG. 10).

The unique, compact angle configuration of the serrated portion 22 of the thumb blade 15 presents a shark-tooth design that enables the serrated portion 22 to not only be able to grip the material that is being cut or sheared, but also to be able to draw this material forward into the blades, for example in anticipation of a subsequent cut.

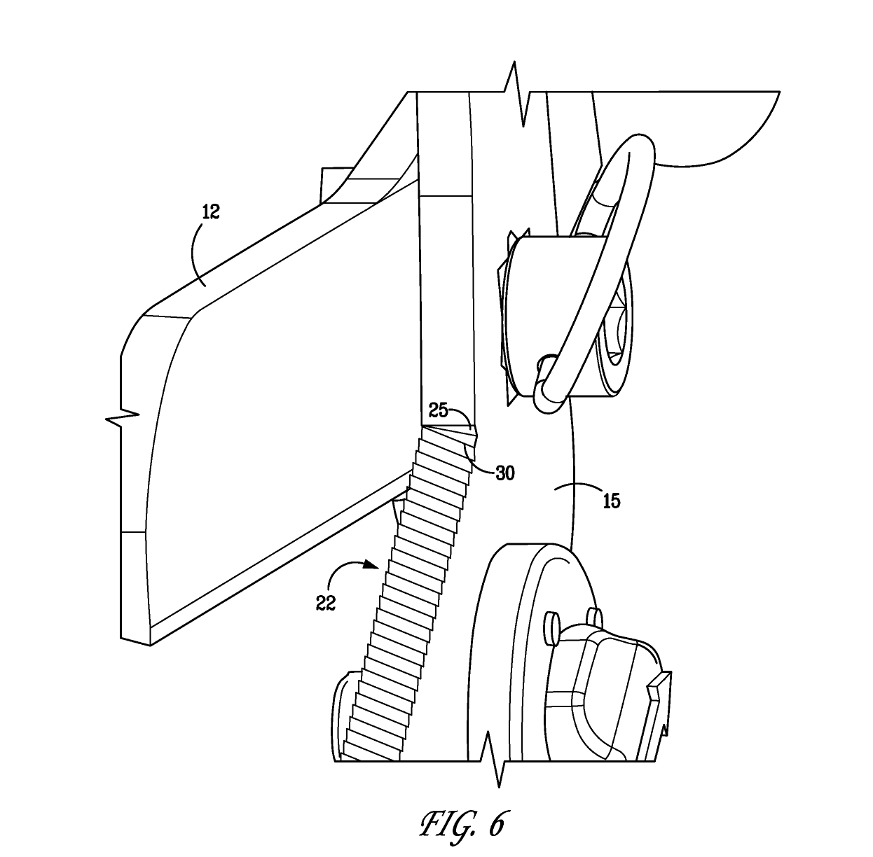

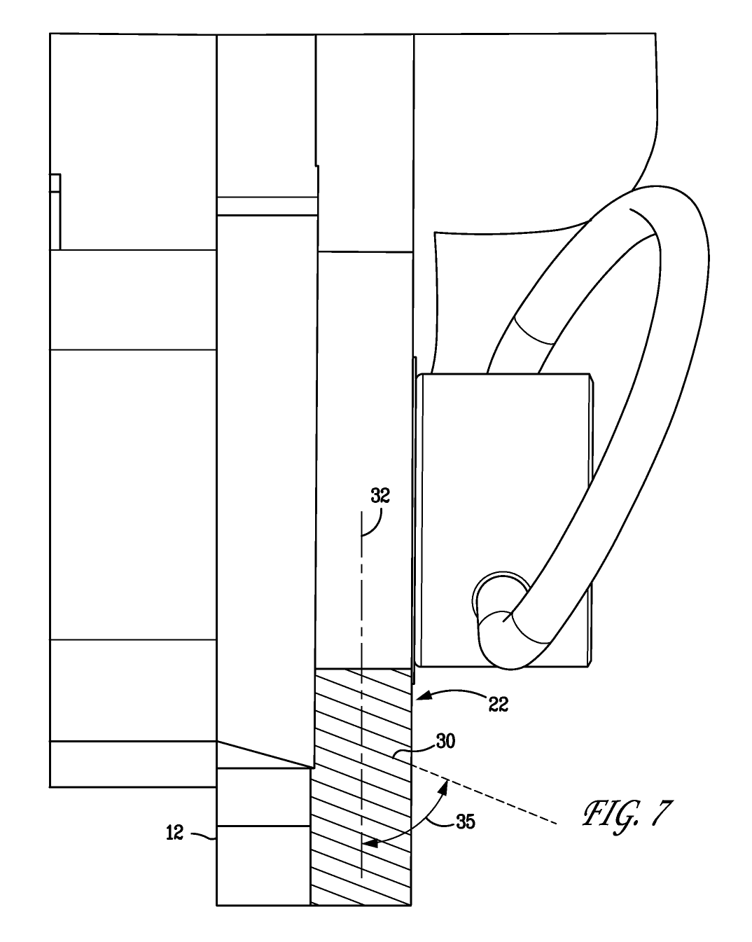

To further facilitate operation of the shearing apparatus 10 of the present application, the inside or facing surfaces of the index blade 12 and the thumb blade 15 can be hollow ground. Hollow grinding of these inside surfaces minimizes friction during shearing by helping to clear the material and keep it from binding between the blades. Such hollow grinding is schematically illustrated, for example, in FIG. 4 for the inner side surface 26 of the thumb blade 15, and in FIGS. 6 and 7 for the inner side surface of the index blade 12.

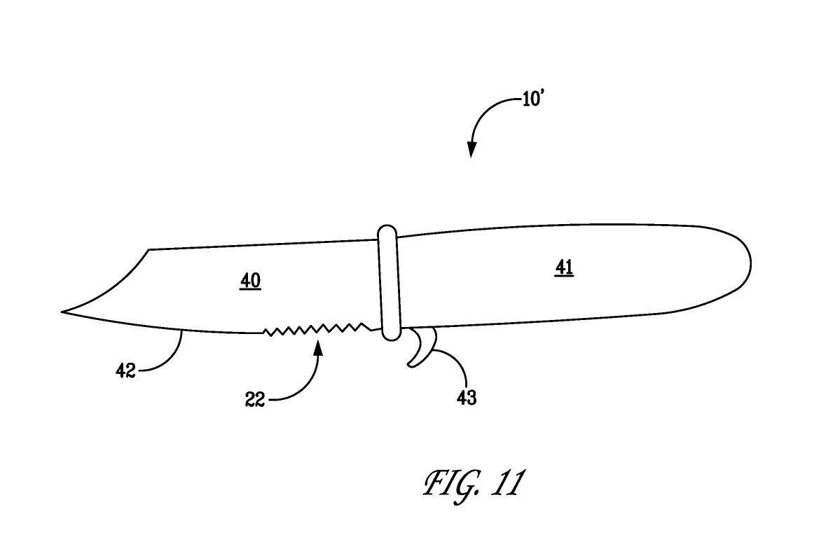

A further exemplary embodiment of applicant's shearing apparatus is illustrated in FIG. 11, and is designated generally by the reference numeral 10′. The shearing apparatus 10′ also incorporates a serrated portion 22 having the unique compound angular configuration described above in conjunction with the embodiment illustrated in FIGS. 1-10. However, with the shearing apparatus 10′, only a single blade portion or element 40 is provided, with a handle means 41 being disposed at one end of the blade portion 40 for pulling or pushing it in order to carry out a shearing or severing action. In the illustrated embodiment, the shearing apparatus 10′ is shown as having both the serrated portion 22 as well as a cutting edge 42 along one side of the blade portion 40. In this embodiment, the serrated portion 22 is closer to the handle 41, although the reverse arrangement could also be provided. In addition, instead of a combination of both a serrated portion 22 and a cutting edge 42 on the same side, it would be possible to provide only the serrated portion 22 on one side, or along with a serrated portion 22 on one side, a cutting blade 42 on the other side. Furthermore, a pull element 43 can optionally be provided on the handle means 41 for a finger of a hand that is holding the handle means to facilitate pulling the blade portion 40 through material that is being severed.

The present invention is, of course, in no way restricted to the specific disclosure of the specification and drawings, but also encompasses any modifications within the scope of the appended claims.

What I claim is:

1. A shearing apparatus, comprising:
at least one blade element for carrying out a shearing or severing action, wherein said at least one blade element is provided with a serrated portion having a configuration that presents a compound angle.

2. A shearing apparatus, according to claim 1, wherein said at least one blade element comprises:
an index portion having an index blade and a first pivot;
a thumb portion having a thumb blade and a second pivot;
a pivot mechanism disposed through both said first and second pivots, wherein said index portion and said thumb portion are pivotable relative to one another about said pivot mechanism; and
wherein one of said thumb blade and said index blade is provided with said serrated portion, while the other of said index blade and said thumb blade is provided with a cutting edge, and wherein said serrated portion and said cutting edge of said thumb blade and said index blade are configured to cooperate with one another during said relative pivoting movement of said index portion and said thumb portion to carry out the shearing or severing action.

3. A shearing apparatus according to claim 2, wherein said serrated portion comprises a plurality of teeth disposed at said compound angle.

4. A shearing apparatus according to claim 3, wherein peaks and troughs of said teeth extend at an angle relative to a longitudinal direction of said thumb blade, and in particular outwardly from an edge of said thumb blade that cooperates with said cutting edge of said index blade and in a direction toward an outer end of said thumb blade, and wherein said peaks and said troughs of said teeth also extend downwardly at an angle from said cooperating edge of said thumb blade into the body of said thumb blade in a direction toward an opposite side of said thumb blade.

5. A shearing apparatus according to claim 4, wherein said angles are in the range of from 72° to 78°.

6. A shearing apparatus according to claim 5, wherein said angles are approximately 75°.

7. A shearing apparatus according to claim 4, wherein inwardly facing sides of said teeth at said cooperating edge of said thumb blade are disposed at an angle that extends inwardly from an inner side surface of said thumb blade toward an opposite side of said thumb blade.

8. A shearing apparatus according to claim 7, wherein said angle is in the range of from 72° to 78°.

9. A shearing apparatus according to claim 8, wherein said angle is approximately 75°.

10. A shearing apparatus according to claim 4, wherein a surface of said index blade that extends between said cutting edge thereof and an outer side surface of said index blade extends at an angle relative to said outer side surface.

11. A shearing apparatus according to claim 4, wherein a peak to peak spacing of said teeth relative to one another is uniform.

12. A shearing apparatus according to claim 11, wherein said peak to peak spacing ranges from 0.014 to 0.028 inches.

13. A shearing apparatus according to claim 4, wherein an angle at the root of said teeth defined by said troughs and adjacent side surfaces of said teeth range from 60° to 90°.

14. A shearing apparatus according to claim 13, wherein said root angle is approximately 75°.

15. A shearing apparatus according to claim 4, wherein an angle at said peaks defined by adjacent side surfaces of said teeth ranges from 60° to 90°.

16. A shearing apparatus according to claim 15, wherein said peak angle is approximately 75°.

17. A shearing apparatus according to claim 2, which further comprises a ripping portion that is configured to be securable to one of said thumb blade and said index blade.

18. A shearing apparatus according to claim 2, wherein inner side surfaces of at least one of said index blade and said thumb blade are hollow ground.

19. A shearing apparatus according to claim 1, wherein said at least one blade element comprises a single blade portion having handle means to enable manipulation of said blade portion for carrying out the shearing or severing action, wherein said serrated portion is provided on at least part of one side of said blade portion.

20. A shearing apparatus according to claim 19, wherein said serrated portion comprises a plurality of teeth disposed at said compound angle, further wherein peaks and troughs of said teeth extend at an angle relative to a longitudinal direction of said blade portion, and in particular outwardly from an edge of said blade portion in a direction toward an outer end of said blade portion, and wherein said peaks and said troughs of said teeth also extend downwardly at an angle from said edge of said blade portion into the body of said blade portion in a direction toward an opposite side of said blade portion.

21. A shearing apparatus according to claim 19, wherein said single blade portion is furthermore provided with a cutting edge, either on said one side of said blade portion with said serrated portion, or on an opposite side of said blade portion.
